(19) United States
(12) Patent Application Publication
(10) Pub. No.: US 2012/0294728 A1
(43) Pub. Date: Nov. 22, 2012

(54) WIND DIODE SYSTEMS

(76) Inventor: Randal Stewart, Alma, MI (US)

(21) Appl. No.: 13/300,052

(22) Filed: Nov. 18, 2011

Related U.S. Application Data
(60) Provisional application No. 61/415,999, filed on Nov. 22, 2010.

(51) Int. Cl. F03D 3/06

(52) U.S. Cl. 416/240

(57) ABSTRACT

A wind diode with vanes having flexible flaps arrayed linearly along flap supports to catch the wind against the flaps supported by a filament array or, rotating to the opposite direction, to allow the wind to pass through the filament array by moving the flaps into a position that does not catch the wind. By using multiple flaps in the array, variations in the wind velocity profile across the vane are accounted for, thereby reducing drag. The wind diode is preferably mast-mounted, with the drive train attached to the exterior of the mast. Vertical and horizontal wind diodes are possible, as is a hybrid that is reconfigurable to be used in either orientation. The drive train preferably uses a continuous variable range transmission to provide constant speed output.

### RELATIONSHIP TO OTHER APPLCIATIONS

This application claims the benefit of U.S. Provisional patent Application Ser. No. 61/415,999 filed Nov. 22, 2010 to the same inventor.

### FIELD OF THE INVENTION

This invention relates to a wind diode for converting wind power to rotational mechanical power. The invention further relates to a wind diode for converting power from moving fluids, such as air, gas, or liquid, to rotational mechanical power and then to transfer the rotational mechanical power to electrical power.

### BACKGROUND

Wind turbines for converting wind power to mechanical rotating power are anciently known. However, improvements are constantly being sought and, as with the present invention, found.

U.S. Pat. No. 3,920,354 for a HORIZONTAL HINGED-FLAP WINDMILL teaches a rudimentary wind diode, including a vertical axle with plurality of vanes having paired, vertically spaced apart, spokes with wires extending between each pair and horizontal hinge supports arrayed across the wires. This omni-directional windmill has some vanes moving with the wind and some vanes moving against the wind at all times. Hinged flaps extend from the hinge supports and move, responsive to the wind, to a horizontal, low drag, position when moving against the wind and to a vertical position, braced by the wires, when moving with the wind. The term “wind diode” refers to the two-state capability of the flaps, being either open to the wind (horizontal) or closed to the wind (vertical). The prior art discloses mechanical hinges for each of the flaps and each flap extends horizontally across the vane. As a result, when each vane first begins to engage the unwanted wind at its radial outward extremity, the wind on the outer end of the flap must lift the entire flap, thereby creating unwanted drag. The use of mechanical hinges creates a susceptibility to mechanical failure at low temperatures due to icing of the hinges. Not disclosed in U.S. Pat. No. 3,920,354 are methods to keep the output speed or output power constant over an operational range of wind speeds.

Therefore, a need exists for a wind diode that has reduced drag. A need also exists for a wind diode system that is economically affordable to construct and market. A need exists for a wind diode system that provides constant rotational speed output, within an operational range of constant or variable wind speeds. A need exists for a wind diode system that is more efficient. A need exists for a wind diode system that can operate over a wide temperature range.

### OBJECTS AND FEATURES OF THE INVENTION

A primary object and feature of the present invention is to overcome the above-mentioned problems and fulfill the above-mentioned needs.

Another object and feature of the present invention is to provide a wind diode that has reduced drag. Another object and feature of the present invention is to provide a wind diode system that is cheaper to construct. Another object and feature of the present invention is to provide a wind diode system that provides constant rotational speed output, within an operational range of wind speeds. Another object and feature of the present invention is to provide a wind diode system that is more efficient. Another object and feature of the present invention is to provide a wind diode system that can operate over a wide temperature range. Another object and feature of the present invention is to provide a wind diode system that is scalable to meet electrical power needs in the ranges of 1-50 KW.

It is an additional primary object and feature of the present invention to provide a wind diode that is safe, inexpensive, easy to clean, easy to install, and easy to maintain. Other objects and features of this invention will become apparent with reference to the following descriptions.

### SUMMARY OF THE INVENTION

In accordance with a preferred embodiment hereof, the present invention provides a wind diode system for converting wind power to mechanical power, the system including: a vane including a frame supporting an array of filaments; a plurality of the vanes spaced apart circumferentially and extending radially from at least one hub, where the hub is mountable on a mast and can freely rotate on the mast when so mounted; a plurality of flap supports spaced apart on each vane of the plurality of vanes; and a plurality of flexible flaps attached without hinges in linear array along at least one the flap support of the plurality of flap supports. The wind diode system, where the plurality of flap supports are filaments of the array of filaments. The wind diode system, where the flap support includes the plurality of flap supports. The wind diode system, including the plurality of the flap supports spaced apart axially and the plurality of flexible flaps linearly arrayed radially. The wind diode system, including the plurality of the flap supports spaced apart radially and the plurality of flexible flaps linearly arrayed axially. The wind diode system, where the plurality of the flexible flaps are coupled to the plurality of the flap supports in positions to enable gravity to assist in moving the flexible flaps. The wind diode system, where the frame may be coupled to the hub in at least first and second orientations, where the second orientation is a ninety-degree rotation, in a plane of the frame, from the first orientation. The wind diode system, mounted on the mast. The wind diode system, where the mast includes a rigging head, operable to couple support wires for supporting the plurality of vanes. The wind diode system, where the hub is mechanically coupled to a drive train. The wind diode system, where the drive train includes magnetic gears. The wind diode system, where the drive train includes a continuous variable range transmission. The wind diode system, where the drive train includes a magnetic continuous variable range transmission. The wind diode system, where the drive train includes a clutch. The wind diode system, where the drive train is coupled to an exterior of the mast.

A wind diode system for converting wind power to mechanical power, the system including: a vane including a frame supporting an array of filaments; a plurality of the vanes spaced apart circumferentially and extending radially from at least one hub, where the hub is mountable on a mast and can freely rotate on the mast when so mounted; a plurality of flap supports spaced apart on each the vane of the plurality of vanes; a plurality of flexible flaps attached without hinges in linear array along each the flap support of the plurality of the flap supports; and a drive gear coupled to the hub. The wind diode system, further including the mast on which the hubs are rotationally mounted, where an exterior of the mast also supports at least one of: a rigging head for supporting support wires for supporting the vanes; a drive shaft gear operable to be engaged with the drive gear; a drive shaft coupled to the drive shaft gear; a clutch driven by the drive shaft; a transmission transmitting output from the clutch to a constant speed rotation. The wind diode system, where the frame may be coupled to the hub in at least first and second orientations, where the second orientation is a ninety-degree rotation, in a plane of the frame, from the first orientation. The wind diode system, including one of: the plurality of the flap supports spaced apart axially and the plurality of flexible flaps linearly arrayed radially; and the plurality of the flap supports spaced apart radially and the plurality of flexible flaps linearly arrayed axially.

A wind diode system for converting wind power to mechanical power, the system including: a vane including a frame supporting an array of filaments; a plurality of the vanes spaced apart circumferentially and extending radially from at least one hub, where the hub is mountable on a mast and can freely rotate on the mast when so mounted; a drive gear coupled to the hub where the mast is also configured to support at least one of: a rigging head for supporting support wires for supporting the vanes; a drive shaft gear operable to be engaged with the drive gear; a drive shaft coupled to the drive shaft gear; a clutch driven by the drive shaft; a transmission transmitting output from the clutch to a constant speed rotation; a plurality of flap supports spaced apart on each the vane of the plurality of vanes; and a plurality of flexible flaps attached without hinges in linear array along each the flap support of the plurality of the flap supports, where one of: the plurality of the flap supports are spaced apart axially and the plurality of flexible flaps are linearly arrayed radially; and the plurality of the flap supports are spaced apart radially and the plurality of flexible flaps are linearly arrayed axially.

### BRIEF DESCRIPTION OF THE DRAWINGS

The above and other objects and advantages of the present invention will become more apparent from the following description taken in conjunction with the following drawings in which:

FIG. 1 is a top plan view illustrating an exemplary wind diode system, with exemplary flaps, according to a preferred embodiment of the present invention;

FIG. 2 is a side elevation view illustrating the exemplary wind diode system, according to the preferred embodiment of FIG. 1;

FIG. 3 is a perspective view illustrating the exemplary wind diode system, according to the preferred embodiment of FIG. 1;

FIG. 4 is a perspective view illustrating an exemplary detail of an exemplary wind diode system, according to the preferred embodiment of FIG. 1;

FIG. 5 is a side elevation view illustrating the exemplary clutch and magnetic transmission of an exemplary wind diode system, according to the preferred embodiment of FIG. 1;

FIG. 6 is a perspective view illustrating an exemplary rigging head of an exemplary wind diode system, according to the preferred embodiment of FIG. 1;

FIG. 7 is a perspective view illustrating an exemplary chassis of an exemplary wind diode system, according to a preferred embodiment of the present invention;

FIG. 8 is a front elevation diagrammatic view illustrating an exemplary horizontal-axis wind diode system, according to a preferred embodiment of the present invention;

FIG. 9 is a perspective view illustrating an exemplary wind diode of the exemplary wind diode systems in an open position, according to a preferred embodiment of the present invention;

FIG. 10 is a perspective view illustrating an exemplary wind diode of the exemplary wind diode systems in a nearly closed position, according to a preferred embodiment of the present invention; and

FIG. 11 is a block diagram illustrating an exemplary power train of the exemplary wind diode systems, according to a preferred embodiment of the present invention.

### DETAILED DESCRIPTION OF THE BEST MODES AND PREFERRED EMBODIMENTS OF THE INVENTION

The term “wind diode” refers to the two-state capability of the flaps, being either open to the wind (horizontal) or closed to the wind (vertical).

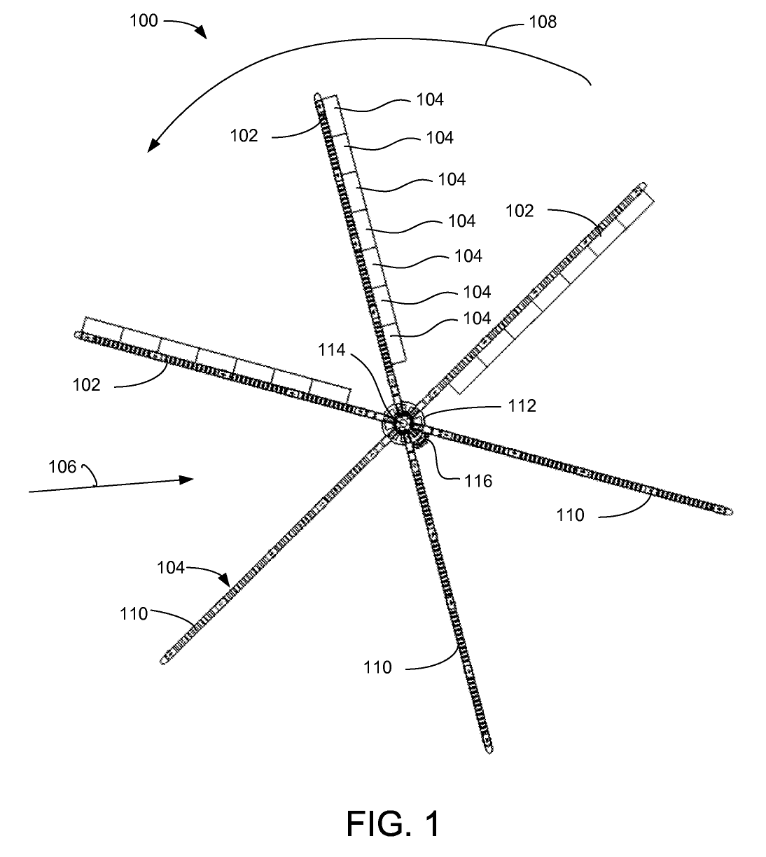

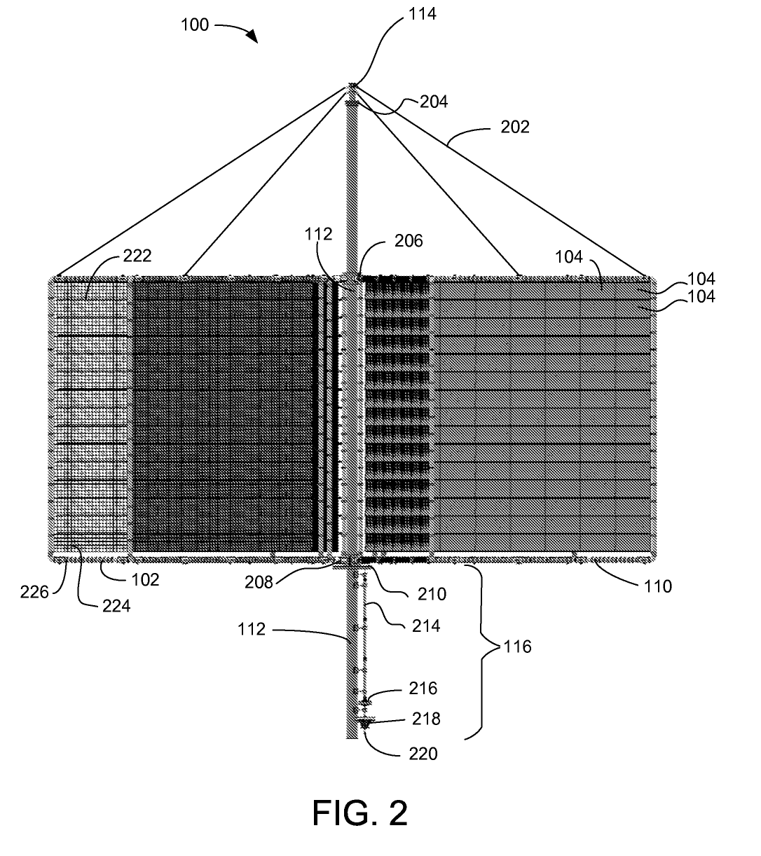

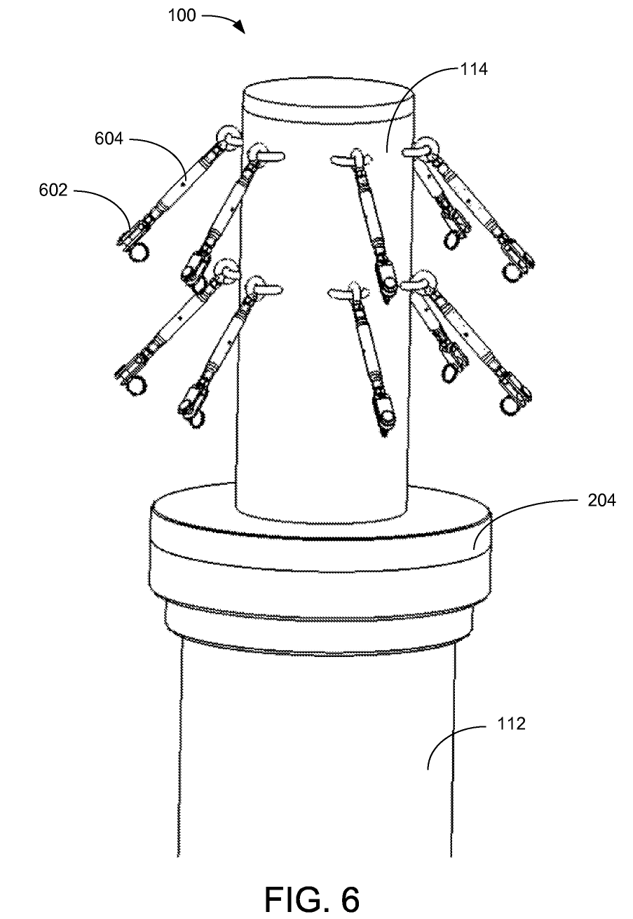

FIG. 1 is a top plan view illustrating an exemplary wind diode system 100, with exemplary flaps 104, according to a preferred embodiment of the present invention. Central mast 112 supports vanes 102 (three each) and 110 (three each) that are identical except for the state of flaps 104 at the moment of time illustrated in FIG. 1. The vanes 102 and 110 are spaced apart circumferentially and coupled to hubs 206 and 208 (see FIG. 2). The vanes 102 and 110 rotate about mast 112 in fixed relationship to one another. Each vane 102 or 110 has a frame 226 (see FIG. 2), a screen 224, a spaced-apart plurality of flap supports 222 (see FIG. 2) and an array of flexible flaps 104 (less than all labeled) that are attached without hinges to flap supports 222. In vanes 102, the flaps 104 are shown blown into the horizontal position by wind 106 impinging on the flaps 104, as shown. In vanes 110, the flaps 104 are shown blown against the screen 224 (see FIG. 2) by wind 106 impinging on the flaps 104. Screen 224 is an array of filaments 224 operable to engage the flaps 104 in the vertical position and transfer the force of the wind 106 to the screen 224 which forces the motion of the frame 226 which rotates the hubs 206 and 208 (see FIG. 2). As a result of the force provided by wind 106, the vanes 102 and 110 rotate counterclockwise 108, as shown. Rigging head 114 provides couplings 602 (see FIG. 6) for support wires 202 (see FIG. 2) for supporting vanes 102 and 110. Rigging head 114 rotates on the mast 112 with vanes 102 and 110. Drive train 116 is attached to the side of the mast.

Preferably, the wind diode system 100 is operated in the atmosphere at heights greater than twenty-five feet to avoid the Earth's atmospheric boundary layer. In particular embodiments, such as extracting power from exhaust gas flows, other operational parameters may be established.

Rather than use a horizontal flap 104 that extends across the horizontal extent of the vane 102 or 110, as in prior art devices, the wind diode system 100 uses a plurality of flaps 104 along the horizontal extent of the vane 102 and 110. The advantage of the horizontal row of flaps 104 is that horizontal variations in the wind velocity on a particular vane 102 due to interference from a leading vane 102 and due to the rotation 108 of the wind vane 102 are accommodated. With prior art devices using single horizontal flaps, the strongest portion of the wind 106 in the horizontal wind gradient must lift the entire flap, creating unwanted drag.

FIG. 2 is a side elevation view illustrating the exemplary wind diode system 100, according to the preferred embodiment of FIG. 1. Mast 112 supports rigging head 114 that supports support wires 202 (less than all shown, one labeled). In a preferred embodiment, the support wires 202 support all of the vertical loads of the vanes 120 and 110, the upper hub 206 and the lower hub 208. In an alternate embodiment, the upper hub 206 and lower hub 208 have bearings coupled to the mast 112 to support all or part of the load. In another alternate embodiment, only one hub, centrally located, may be used. In various other embodiments, more than two hubs 206 and 208 may be used.

Each vane has a spaced-apart plurality of flap supports 222 (one of fourteen labeled) for attaching flexible flaps 104 and screen 224 for supporting the flaps 104 in the downward, vertical, closed, or wind-catching, position. The plurality of flap supports 222 are spaced apart axially and the plurality of flexible flaps 104 are linearly arrayed radially along each flap support 222. The top edges of flexible flaps 104 are coupled to flap supports 222, causing gravity to assist in closing the flaps 104 and resist opening the flaps 104. In a particular embodiment, flap supports 222 may be elements, or filaments, of screen 224. In a particular embodiment, a customized screen 224 may be manufactured having a grid size and a filament strength optimized for the particular embodiment.

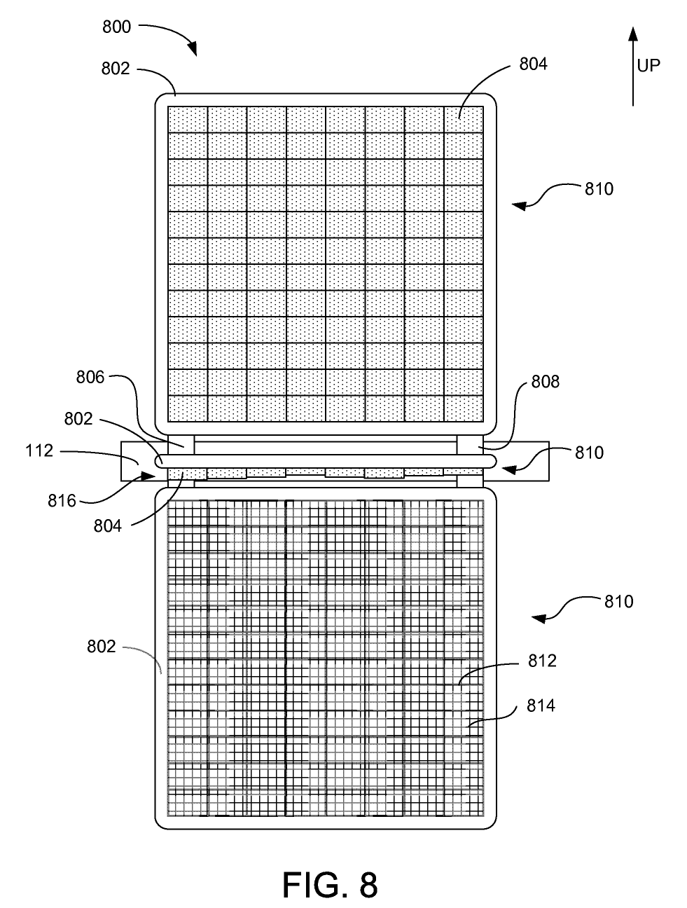

The vanes 102 and 110 are preferably made as individual units that can be installed in more than one orientation. In a particular embodiment, the vanes 102 and 110 may be installed in an orientation that is ninety degrees from that shown, and used with a horizontal mast 112 with bearings (not shown) maintaining hubs 206 and 208 in place. Horizontal wind diode systems 100 may be used in roof top and exhaust stack applications, for non-limiting examples. See FIG. 8 and the discussion below.

In an alternate embodiment, vanes 102 and 110 may have curved cross sections in the plane transverse to the mast 112. In a particular alternate embodiment, vanes 102 and 110 may have semi-circular cross sections and be arranged in an original Savonius rotor configuration.

Drive train 116 includes drive shaft 214 that is rotated by drive gear 210, which, in turn, is connected to lower hub 208 and so rotates with the vanes 102 and 110. Drive shaft 214 drives clutch 216 when a minimum operating rotational velocity is achieved, transferring torque to transmission 218 to produce a rotational mechanical output on output shaft 220. Preferably, transmission 218 is a continuous variable range transmission 218 and is more preferably a magnetic continuous variable range transmission 218. In alternate embodiments, other types of transmissions may be used. The drive train 116 is attached to exterior of the mast 112, as will be discussed in further detail below.

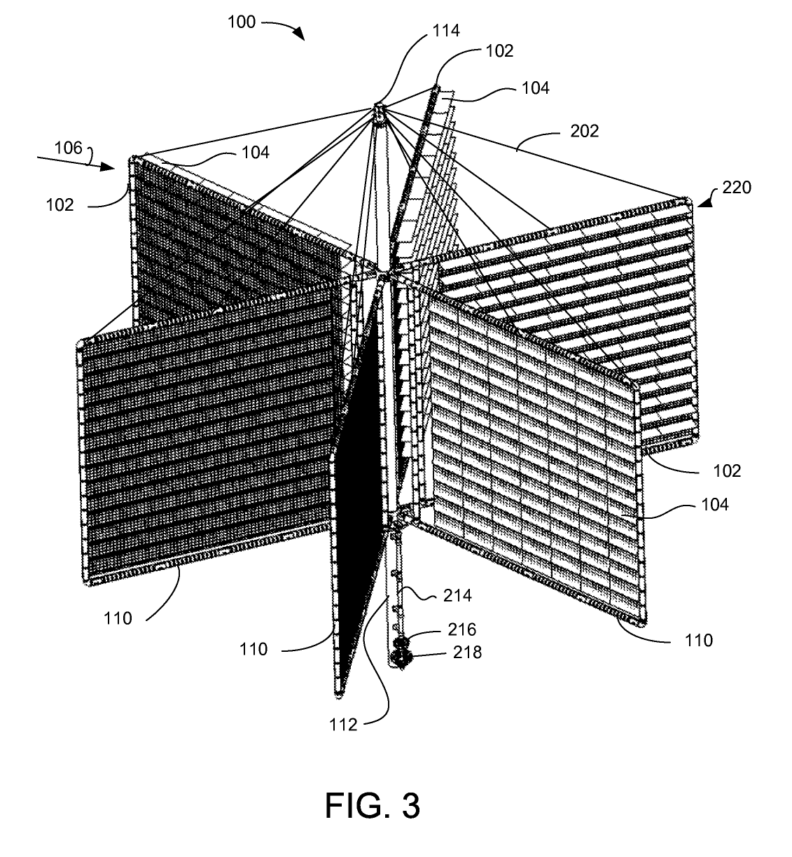

FIG. 3 is a perspective view illustrating the exemplary wind diode system 100, according to the preferred embodiment of FIG. 1. All support wires 202 are shown. The wind diode is scalable to meet consumer electrical power needs in the ranges of 1-50 KW with respect to available wind loading.

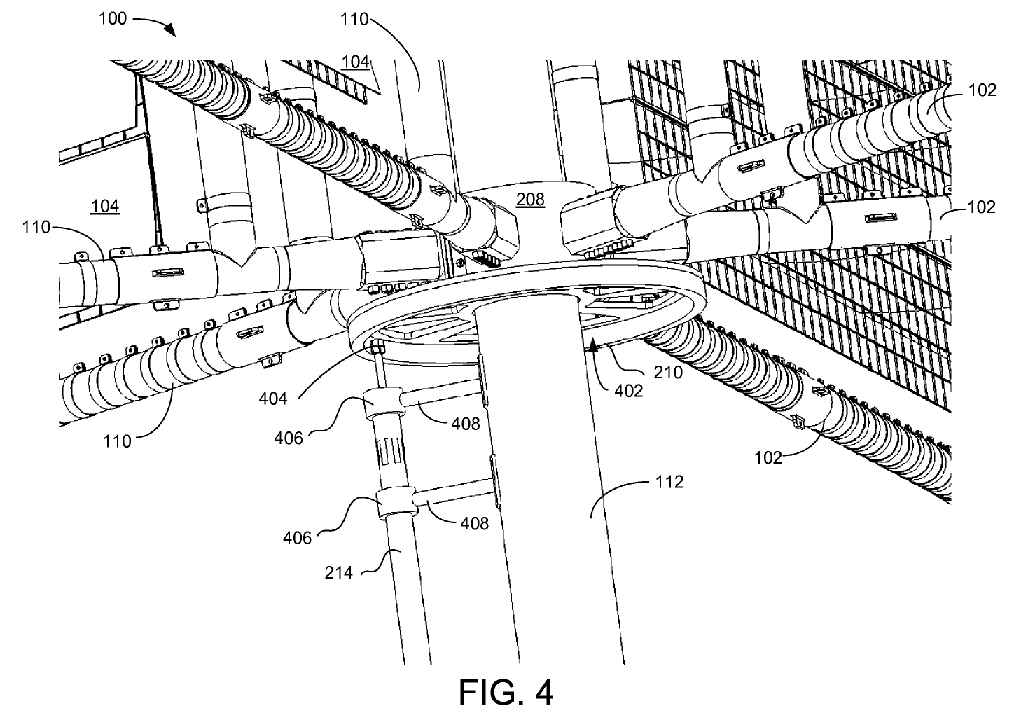

FIG. 4 is a perspective view illustrating an exemplary detail of the exemplary wind diode system 100, according to the preferred embodiment of FIG. 1. Drive gear 210 is preferably a magnetic drive gear 210, having a plurality of magnetic poles (not shown) attached to or doped into inner drive gear surface 402. Drive shaft gear 404 is also preferably a magnetic drive shaft gear 404 and is driven by magnetic drive gear 402. In an alternate embodiment, drive gear 210 and drive shaft gear 404 may be conventional gears. Drive shaft 214 is supported on the exterior of mast 112 by standoffs 408 and couplings 406.

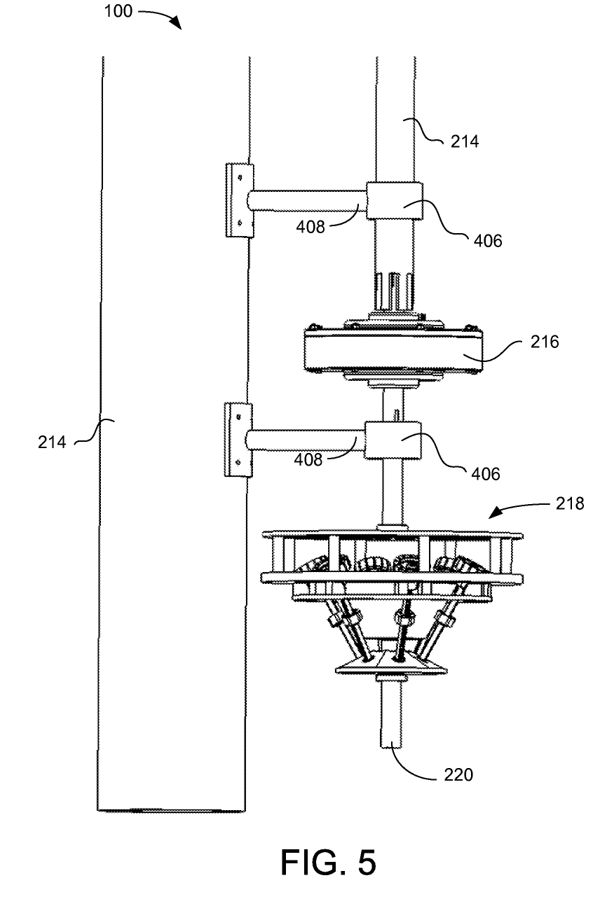

FIG. 5 is a side elevation view illustrating the exemplary clutch 216 and magnetic continuous variable range transmission 218 of an exemplary wind diode system 100, according to the preferred embodiment of FIG. 1. The drive shaft 214, clutch 216 and magnetic continuous variable range transmission 218 are attached to the exterior of the mast 112 via standoffs 408 and coupling 406. In a preferred embodiment, a cover and a controller is provided for the magnetic continuous variable range transmission 218. Various types of clutches 216 and transmissions 218 may be used in various alternate embodiments. Continuous variable range transmissions 218 are preferred for their ability to transfer the variable speed inputs from the vanes 102 and 110 to a constant speed output shaft 220. The attachment of drive train 116 to mast 112 is preferred. In alternate embodiments, the drive train 116 may be separately located. For example, drive train 116 may have its own support.

FIG. 6 is a perspective view illustrating an exemplary rigging head 114 of an exemplary wind diode system 100, according to the preferred embodiment of FIG. 1. Non-rotating mast 112 supports rotatable bearing 204 that supports rigging head 114. Rigging head 114 supports a plurality of support wire couplings 602 (one of ten labeled) used to secure support wires 202 to rigging head 114. Support wire couplings 602 have turnbuckles 604 (one of ten labeled) for adjusting the tension of the support wires 202. The illustrated support wire couplings 602 are exemplary, and various couplings for coupling wire to a structure may be used in various embodiments.

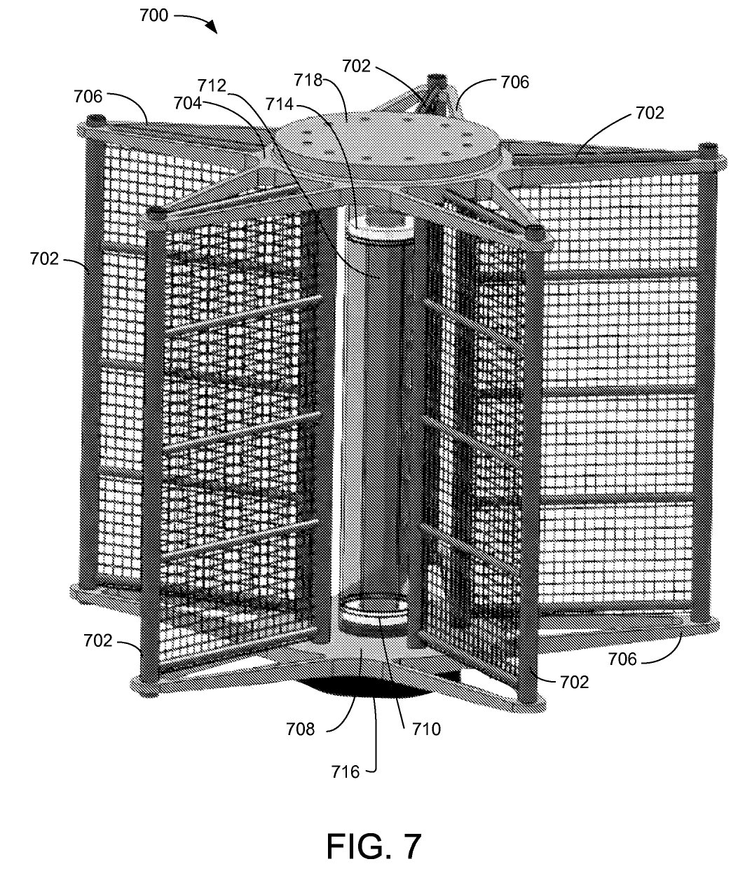

FIG. 7 is a perspective view illustrating an exemplary chassis of an exemplary wind diode system 700, according to a preferred embodiment of the present invention. Wind diode system 700 uses flaps 104 in the same way as wind diode system 100, but the flaps 104 are not shown. Wind diode system 700 has five vanes 702 mounted between two upper and lower hubs 704 and 708, respectively. Hub 708 includes a plurality of triangular supports 706 (four of five shown, one of four labeled) extending to support the radially outward bottom end of each vane 702, as shown. Hub 704 includes a plurality of triangular supports 706 (one of five labeled) extending to support the radially outward top end of each vane 702, as shown. Hubs 704 and 708 rotate on axle 712 via top and bottom bearings 714 and 710, respectively. Pedestal 716 may include at least a portion of a drive train (not shown). Top plate 718 may couple an additional wind diode system 700 to dorm a stack. Wind diode system 700 is ruggedly built for use in high velocity wind or gas streams, including those that are man-made.

FIG. 8 is a front elevation diagrammatic view illustrating an exemplary horizontal axis wind diode 800, according to a preferred embodiment of the present invention. Hubs 806 and 808 mount vanes 810 rotatably to mast 112. In this illustration, the wind direction is into the page. Each vane 810 has a frame 802 supporting flap supports 812 (one of twelve labeled) and filament array 814. Flap supports 812 support one edge of each flap 804 (two of one hundred four shown is labeled). The top vane 810 is shown with the flexible flaps 804 against filament array 814, receiving the force of the wind to push the vane 810. The top edges of the flexible flaps 804 are coupled without hinges to the flap supports 812. For top vane 810, gravity also assists in moving the flexible flaps 804 to the vertical (closed) position. The middle vane 810, oriented frame 802 forward at the moment illustrated, shows flaps 804 in intermediate positions responding to horizontal gradients in the wind speed. Bottom vane 810 shows the flap supports 812 and the filament array 814 as the flexible flaps 804 for the bottom vane 810 are blown horizontal by the wind and are behind flap supports 812. For bottom vane 810, gravity also assists in moving the flexible flaps 804 to the horizontal (open) position, as the edges of the flexible flaps 804 that were connected top edges when the vane 810 was on top are now connected bottom edges. The plurality of flap supports 812 are spaced apart radially and the plurality of flexible flaps 804 are linearly arrayed axially on each flap support 812.

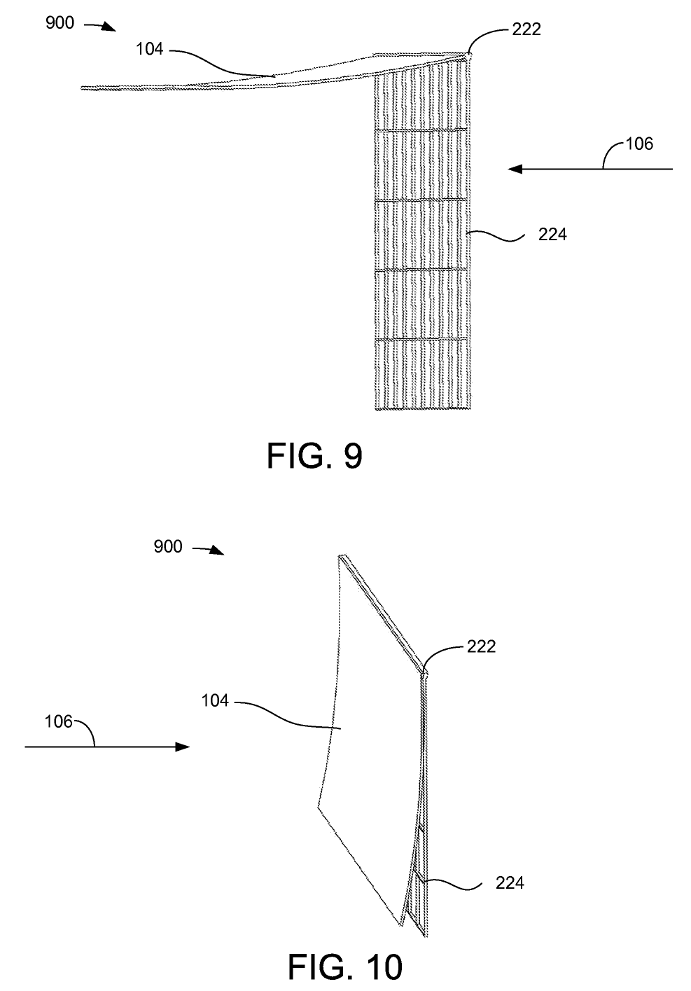

FIG. 9 is a perspective view illustrating an exemplary wind diode 900 of the exemplary wind diode systems 100 and 700 in an open position, according to a preferred embodiment of the present invention. A portion of screen 224 is permeable to wind 106 which forces flexible flap 104 upward, flexing about the line of attachment between flap 104 and a portion of flap support 222. In other embodiments, screens 224 may be of various designs with openings of various shapes.

FIG. 10 is a perspective view illustrating an exemplary wind diode 900 of the exemplary wind diode systems 100 and 700 in a nearly closed position, according to a preferred embodiment of the present invention. As the vane 102 or 110 rotates to a different angle to wind 106, the wind tend to push the flexible flap 104 against the portion of screen 224, thus transferring the force of the wind 106 to the screen 224, and so to the frame 226 and thence to the hubs 206 and 208, etc.

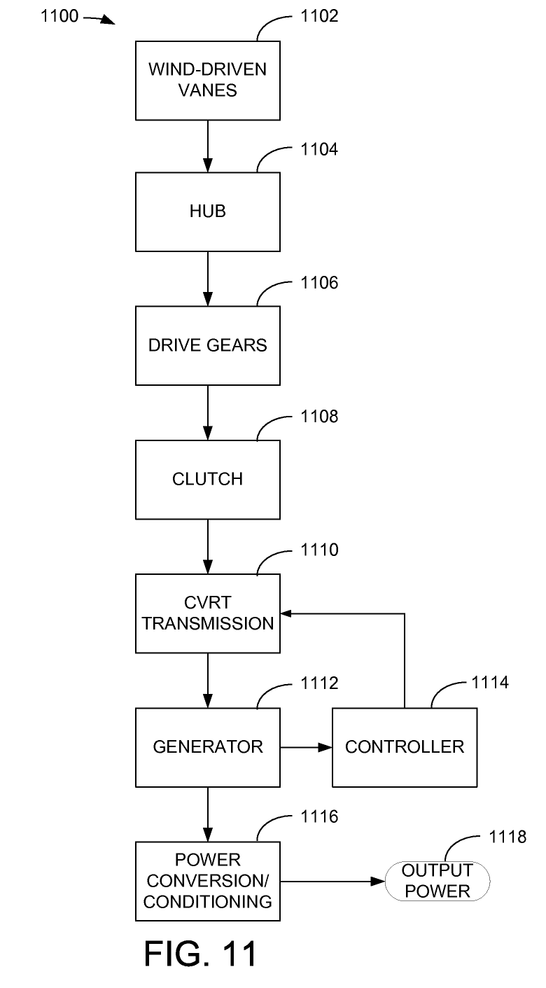

FIG. 11 is a block diagram illustrating an exemplary power train 1102 of the exemplary wind diode systems 100 and 700, according to a preferred embodiment of the present invention. Wind-driven vanes 1102 includes exemplary vanes 102 and 110 or 702 with wind diodes 900, mounted on exemplary mast 112 via exemplary hubs 206 and 208 or 704 and 708. Hub 1104, such as exemplary hubs 206 and 208 or 704 and 708, transmit the rotational force of the wind-driven vanes 1102 to drive gears 1106, such as exemplary drive gear 210 and driveshaft gear 404. The rotational mechanical power is applied to the input shaft of clutch 1108, such as exemplary clutch 216. If the rotational velocity of the input shaft of the clutch 1108 meets a predetermined threshold, the clutch 1108 engages and drives the input to a CVRT transmission 1110, such as transmission 218. The CVRT transmission drives generator 1112 at an approximately constant rotational velocity. The electrical output of the generator 1112 is supplied to power conversion and conditioning circuitry 1116, if needed. Controller 1114 monitors generator 1112, either as to input rotational speed or electrical output, and controls the CVRT transmission 1110 to maintain constant output. The converted and conditioned power output 1118 is supplied to users.

Although applicant has described applicant's preferred embodiments of this invention, it will be understood that the broadest scope of this invention includes any variation within the scope of the claims. Such scope is limited only by the claims as read in connection with the specification. Further, many other advantages of applicant's invention will be apparent to those skilled in the art from the above descriptions and the below claims.

I claim:

1. A wind diode system for converting wind power to mechanical power, the system comprising:
a. a vane comprising a frame supporting an array of filaments;
b. a plurality of said vanes spaced apart circumferentially and extending radially from at least one hub, wherein said at least one hub is mountable on a mast and can freely rotate on said mast when so mounted;
c. a plurality of flap supports spaced apart on each said vane of said plurality of vanes; and
d. a plurality of flexible flaps attached without hinges in linear array along at least one said flap support of said plurality of said flap supports.

2. The wind diode system of claim 1, wherein said plurality of flap supports are filaments of said array of filaments.

3. The wind diode system of claim 1, wherein said at least one flap support comprises said plurality of flap supports.

4. The wind diode system of claim 1, comprising said plurality of said flap supports spaced apart axially and said plurality of flexible flaps linearly arrayed radially.

5. The wind diode system of claim 1, comprising said plurality of said flap supports spaced apart radially and said plurality of flexible flaps linearly arrayed axially.

6. The wind diode system of claim 5, wherein said plurality of said flexible flaps are coupled to said plurality of said flap supports in positions to enable gravity to assist in moving said flexible flaps.

7. The wind diode system of claim 1, wherein said frame may be coupled to said at least one hub in at least first and second orientations, wherein said second orientation is a ninety-degree rotation, in a plane of said frame, from said first orientation.

8. The wind diode system of claim 1, mounted on said mast.

9. The wind diode system of claim 8, wherein said mast comprises a rigging head, operable to couple support wires for supporting said plurality of vanes.

10. The wind diode system of claim 1, wherein said at least one hub is mechanically coupled to a drive train.

11. The wind diode system of claim 10, wherein said drive train comprises magnetic gears.

12. The wind diode system of claim 10, wherein said drive train comprises a continuous variable range transmission.

13. The wind diode system of claim 10, wherein said drive train comprises a magnetic continuous variable range transmission.

14. The wind diode system of claim 10, wherein said drive train comprises a clutch.

15. The wind diode system of claim 10, wherein said drive train is coupled to an exterior of said mast.

16. A wind diode system for converting wind power to mechanical power, the system comprising:
a. a vane comprising a frame supporting an array of filaments;
b. a plurality of said vanes spaced apart circumferentially and extending radially from at least one hub, wherein said at least one hub is mountable on a mast and can freely rotate on said mast when so mounted;
c. a plurality of flap supports spaced apart on each said vane of said plurality of vanes;
d. a plurality of flexible flaps attached without hinges in linear array along each said flap support of said plurality of said flap supports; and
e. a drive gear coupled to said at least one hub.

17. The wind diode system of claim 16, further comprising said mast on which said hubs are rotationally mounted, wherein an exterior of said mast also supports at least one of:
a. a rigging head for supporting support wires for supporting said vanes;
b. a drive shaft gear operable to be engaged with said drive gear;
c. a drive shaft coupled to said drive shaft gear;
d. a clutch driven by said drive shaft;
e. a transmission transmitting output from said clutch to a constant speed rotation.

18. The wind diode system of claim 16, wherein said frame may be coupled to said at least one hub in at least first and second orientations, wherein said second orientation is a ninety-degree rotation, in a plane of said frame, from said first orientation.

19. The wind diode system of claim 16, comprising one of:
a. said plurality of said flap supports spaced apart axially and said plurality of flexible flaps linearly arrayed radially; and
b. said plurality of said flap supports spaced apart radially and said plurality of flexible flaps linearly arrayed axially.

20. A wind diode system for converting wind power to mechanical power, the system comprising:
a. a vane comprising a frame supporting an array of filaments;
b. a plurality of said vanes spaced apart circumferentially and extending radially from at least one hub, wherein said at least one hub is mountable on a mast and can freely rotate on said mast when so mounted;
c. a drive gear coupled to said at least one hub
d. wherein said mast is also configured to support at least one of:
i. a rigging head for supporting support wires for supporting said vanes;
ii. a drive shaft gear operable to be engaged with said drive gear;
iii. a drive shaft coupled to said drive shaft gear;
iv. a clutch driven by said drive shaft;
v. a transmission transmitting output from said clutch to a constant speed rotation;
e. a plurality of flap supports spaced apart on each said vane of said plurality of vanes; and
f. a plurality of flexible flaps attached without hinges in linear array along each said flap support of said plurality of said flap supports, wherein one of:
i. said plurality of said flap supports are spaced apart axially and said plurality of flexible flaps are linearly arrayed radially; and
ii. said plurality of said flap supports are spaced apart radially and said plurality of flexible flaps are linearly arrayed axially.
